(19) United States
(12) Patent Application Publication
(10) Pub. No.: US 2026/0343429 A1
(43) Pub. Date: Oct. 29, 2026

(54) METHODS, ARCHITECTURES, APPARATUSES AND SYSTEMS FOR POWER MEASUREMENT AND REPORT FOR COORDINATED SPATIAL REUSE TRANSMISSIONS

(71) Applicant: InterDigital Patent Holdings, Inc., Wilmington, DE (US)

(72) Inventors: Ying Wang, Easton, PA (US); Hanqing Lou, Syosset, NY (US); Rui Yang, Melville, NY (US); Mahmoud Saad, L’Ile Bizard, Montreal (CA)

(21) Appl. No.: 19/193,357

(22) Filed: Apr. 29, 2025

(51) Int. Cl. H04W 52/32; H04B 17/318; H04L 5/00

(52) U.S. Cl. CPC H04W 52/325; H04B 17/328; H04L 5/0023

(57) ABSTRACT

Methods, architectures, apparatuses, and systems directed to power measurement and report for coordinated spatial reuse transmissions are described herein. In an embodiment, a first access point (AP) may be configured to receive from a first station (STA) associated with the first AP, a first transmission that may include power measurement information and an AP identifier identifying a second AP. In various embodiments, the power measurement information may be associated with a second transmission received from the second AP and measured at the first STA. In various embodiments, the first STA may not be associated with the second AP. The first AP may be configured to determine, based on the power measurement information, a power value to be used by the second AP for transmitting a third transmission. The first AP may be configured to transmit, to the second AP, a fourth transmission that may include the power value.

### TECHNICAL FIELD

The present disclosure is generally directed to the fields of communications, software and encoding, including methods, architectures, apparatuses, and systems directed to power measurement and report for coordinated spatial reuse (Co-SR) transmissions.

### BACKGROUND

A wireless local area network (WLAN) in infrastructure basic service set (BSS) mode has an access point (AP) for the BSS and one or more stations (STAs) associated with the AP. The AP may have access or interface to a distribution system (DS) or another type of wired/wireless network carrying traffic in and out of the BSS. Embodiments described herein have been designed with the foregoing in mind.

### SUMMARY

Methods, architectures, apparatuses, and systems directed to power measurement and report for coordinated spatial reuse transmissions are described herein. In an embodiment, a first AP may include circuitry including a transmitter, a receiver, a processor, and memory. The first AP may be configured to receive from a first station (STA) associated with the first AP, a first transmission that may include power measurement information and an AP identifier, the AP identifier identifying a second AP. In various embodiments, the power measurement information may be associated with a second transmission received from the second AP and measured at the first STA. In various embodiments, the first STA may not be associated with the second AP. The first AP may be configured to determine, based on the power measurement information, a power value to be used by the second AP for transmitting a third transmission. The first AP may be configured to transmit, to the second AP, a fourth transmission that may include the power value.

In an embodiment, a first method implemented in a first AP may include receiving from a first station (STA) associated with the first AP, a first transmission that may include power measurement information and an AP identifier, the AP identifier identifying a second AP. In various embodiments, the power measurement information may be associated with a second transmission received from the second AP and measured at the first STA. In various embodiments, the first STA may not be associated with the second AP. The first method may include determining, based on the power measurement information, a power value to be used by the second AP for transmitting a third transmission. The first method may include transmitting, to the second AP, a fourth transmission that may include the power value.

In an embodiment, a second AP may include circuitry including a transmitter, a receiver, a processor, and memory. The second AP may be configured to transmit a second transmission to be used by a first station (STA) associated with a first AP to perform power measurement, the first STA not being associated with the second AP. In various embodiments, the second transmission may include an AP identifier, the AP identifier identifying the second AP. The second AP may be configured to receive a fourth transmission from the first AP. In various embodiments, the fourth transmission may include a power value to be used by the second AP for transmitting a third transmission. The second AP may be configured to transmit to a second STA associated with the second AP, the third transmission based on the power value. In various embodiments, the third transmission may share a same set of resources as the first AP may have used for a fifth transmission.

In an embodiment, a second method implemented in a second AP may include transmitting a second transmission to be used by a first station (STA) associated with a first AP to perform power measurement, the first STA not being associated with the second AP. In various embodiments, the second transmission may include an AP identifier, the AP identifier identifying the second AP. The second method may include receiving a fourth transmission from the first AP. In various embodiments, the fourth transmission may include a power value to be used by the second AP for transmitting a third transmission. The second method may include transmitting to a second STA associated with the second AP, the third transmission based on the power value. In various embodiments, the third transmission may share a same set of resources as the first AP may have used for a fifth transmission.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2A is a diagram illustrating a transmission opportunity (TXOP) level Co-SR transmission scheme;

FIG. 2B is a diagram illustrating the signal and interference paths between two concurrent Co-SR downlink transmission pairs;

FIG. 3 is a diagram illustrating an example of Co-SR protocol;

FIG. 4 is a diagram illustrating an example of power measurement and report stage of Co-SR;

FIG. 5 is a diagram illustrating the transmit power control (TPC) report element format used in IEEE P802.11-REVme™/D7.0;

FIG. 6 is a diagram illustrating an example method for power measurement on beacon/measurement pilot frames with explicit transmit (TX) power indication;

FIG. 7 is a diagram illustrating an example method for power measurement on beacon/measurement pilot frames with a default TX power;

FIG. 8 is a diagram illustrating an example method for power measurement on beacon/measurement pilot frames with a TX power associated with a timestamp;

FIG. 9 is a diagram illustrating an example of a simplified measurement report field for Co-SR beacon report;

FIG. 10 is a diagram illustrating an ultra-high reliability (UHR) sequential null data packet (NDP) sounding sequence initiated from AP1 to sound on AP1 and AP2;

FIG. 11 is a diagram illustrating an UHR joint sounding sequence initiated from AP1 to sound on AP1 and AP2;

FIG. 12 is a diagram illustrating an example invite/response and initial control frame/initial control response frame exchange sequence for Co-SR;

FIG. 13 is a diagram illustrating an example method for power measurement and report for coordinated spatial reuse transmissions, implemented in a first AP; and

FIG. 14 is a diagram illustrating an example method for power measurement and report for coordinated spatial reuse transmissions, implemented in a second AP.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

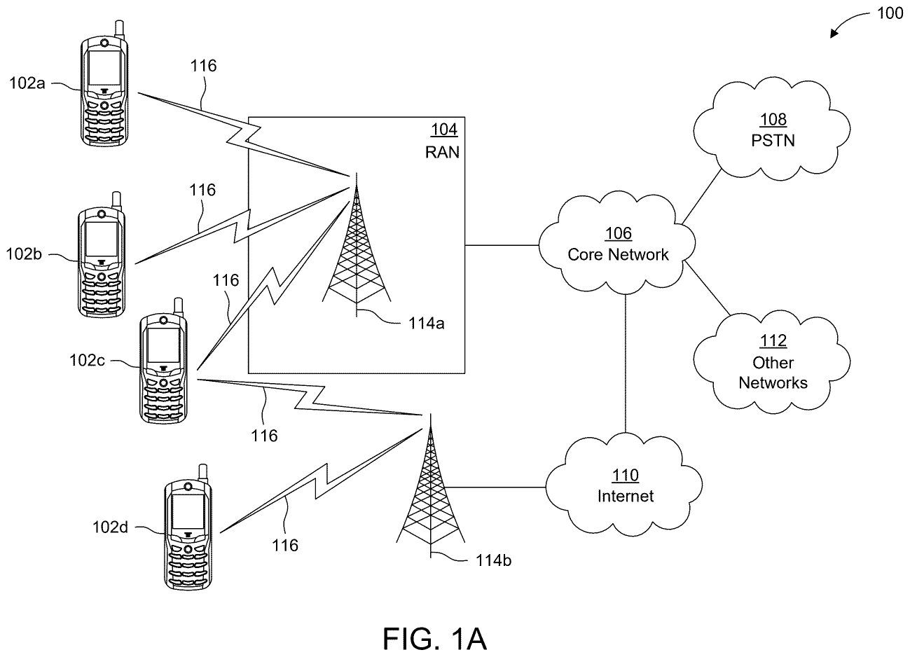

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as Institute of electrical and electronics engineers (IEEE) 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, carrier sense multiple access with collision avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (e.g., contiguous, or non-contiguous), one or more subchannels within a channel, one or more resource units (RUs) within an orthogonal frequency division multiple access (OFDMA) system, whereby assigned one or more RUs may be adjacent (e.g., contiguous) or non-contiguous, occupying one or more channels or subchannels, etc.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the medium access control (MAC) layer, entity, etc.

High Efficiency Wireless (HEW or 802.11ax) STAs may support 20 MHz, 40 MHz, 80 MHz, and/or 160 MHz wide channels capable of transmission over 2.4 GHz, 5 GHz, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., ultra-high reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding Wi-Fi communications into the millimeter-wave frequency band (integrated millimeter-wave-IMMW), energy harvesting based on of Wi-Fi RF signals for facilitating WLAN communications of low-power IoT devices, and the randomization of MAC addresses in WLANs.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by an AP/STA from the network, for example, through system information or via any kind of protocol message. Although not explicitly mentioned throughout embodiments described herein, the same (e.g., configuration) information may be pre-configured in the AP/STA (e.g., via any kind of pre-configuration methods such as e.g., via factory settings), such that this (e.g., configuration) information may be used by the AP/STA without being received from the network.

Throughout embodiments described herein, the expression “the AP/STA may be configured with a set of parameters” is equivalent or may be used interchangeably with “the AP/STA may receive configuration information (e.g., from another network element) indicating a set of parameters”. Throughout embodiments described herein, the expressions “the AP/STA may report something”, and “the AP/STA may be configured to report something” is equivalent or may be used interchangeably with “the AP/STA may transmit (e.g., reporting) information indicating something”. Throughout embodiments described herein, the expression “the AP/STA may provide (/be provided) with a set of parameters (/something)” is equivalent or may be used interchangeably with “the AP/STA may transmit (/receive) information indicating a set of parameters (/something)”.

In embodiments described herein, “a” and “an” and similar phrases are to be interpreted as “one or more” and “at least one”. Similarly, any term which ends with the suffix “(s)” is to be interpreted as “one or more” and “at least one”. The term “may” is to be interpreted as “may, for example”.

A symbol “/” (e.g., forward slash) may be used herein to represent “and/or”, where for example, “A/B” may imply “A and/or B”.

In embodiments described herein, “list of”, “set of” and “one or more of” may be used interchangeably.

In embodiments described herein, “identity” and “identifier” may be used interchangeably to refer to how a network element (or an AP/STA) may be identified.

In embodiments described herein, a STA may refer to any of an AP STA and a non-AP STA. The architecture depicted at FIG. 1B for a WTRU 102 may be applicable more generally to any of an AP STA and a non-AP.

In embodiments described herein, the terms “AP” and “AP STA” may be used interchangeably.

In embodiments described herein, the terms “frame” and “transmission” may be used interchangeably.

In embodiments described herein, a transmission opportunity (TXOP) may refer to an interval of time during which a particular (e.g., quality-of-service (QoS)) STA may (e.g., have the right to) initiate frame exchange sequences onto the wireless medium (WM).

In embodiments described herein, spatial reuse (SR) refers to the transmission of a physical layer protocol data unit (PPDU) on the medium under certain conditions when another PPDU has been detected that would otherwise have prevented the transmission.

In embodiments described herein, a trigger based physical layer protocol data unit (TB PPDU) may refer to a PPDU transmitted with any of high efficiency (HE) TB PPDU (HE TB PPDU) format or extremely high throughput (EHT) TB PPDU (EHT TB PPDU) format.

In embodiments described herein, an overlapping basic service set (OBSS) may refer to a basic service set (BSS) operating on the same channel as the station's BSS and within (partly or wholly) its basic service area (BSA).

In embodiments described herein, a basic service set (BSS) color (BSS color) may refer to an identifier for a BSS or for a set of BSSs belonging to a multiple basic service set identifier (BSSID) set or a co-hosted BSSID set.

For the sake of clarity, embodiments are described herein with 20 MHz as an example of subchannel. Embodiments described herein are not limited to 20 MHz subchannels and may be applicable to subchannels of any size of the PPDU bandwidth (e.g., 40 MHz or any other size).

A WLAN in infrastructure basic service set (BSS) mode has an access point (AP) for the BSS and one or more stations (STAs) associated with the AP. The AP may have access or interface to a distribution system (DS) or another type of wired/wireless network carrying traffic in and out of the BSS. Traffic to STAs originating from outside the BSS may arrive through the AP and may be delivered to the STAs. Traffic originating from STAs to destinations outside the BSS may be sent to the AP to be delivered to the respective destinations. Traffic between STAs within the BSS may (e.g., also) be sent through the AP where the source STA may send traffic to the AP and the AP may deliver the traffic to the destination STA. Traffic between STAs within a BSS may be referred to as peer-to-peer traffic. Such peer-to-peer traffic may (e.g., also) be sent directly between the source and destination STAs with a direct link setup (DLS) using an IEEE 802.11e DLS or an IEEE 802.11z tunneled DLS (TDLS). A WLAN using independent BSS (IBSS) mode has no AP, and the STAs using such IBSS may communicate directly with each other. This mode of communication may be referred to as an “ad-hoc” mode of communication.

Using the IEEE 802.11ac infrastructure mode of operation, the AP may transmit a beacon on a fixed channel, e.g., the primary channel. This channel may be 20 MHz wide and may be the operating channel of the BSS. This channel may be used by the STAs to establish a connection with the AP. The channel access mechanism in an IEEE 802.11 system is based on carrier sense multiple access with collision avoidance (CSMA/CA). In this mode of operation, a (e.g., every) STA, including the AP, may sense occupancy or vacancy of the primary channel. If the channel is detected to be busy, the STA may back off. Hence only one STA may transmit at any given time, frequency and space resource in a (e.g., each) BSS.

In IEEE 802.11n (described in IEEE Std 802.11™-2020), high throughput (HT) STAs may also use a 40 MHz wide channel for communication. This is achieved by combining the primary 20 MHz channel, with an adjacent 20 MHz channel to form a 40 MHz wide contiguous channel.

In IEEE 802.11ac (described in IEEE P802.11ax/D8.0), very high throughput (VHT) STAs may support 20 MHz, 40 MHz, 80 MHz, and 160 MHz wide channels. The 40 MHz, and 80 MHz, channels may be formed by combining contiguous 20 MHz channels as described herein for IEEE 802.11n. A 160 MHz channel may be formed by combining eight contiguous 20 MHz channels, or by combining two non-contiguous 80 MHz channels, which may also be referred to as an 80+80 configuration. For the 80+80 configuration, at the transmitter, the data, after channel encoding, may be passed through a segment parser that may divide the data into two streams. Inverse fast Fourier transform (IFFT) and time domain processing may be done on a (e.g., each) stream separately. The two streams may be mapped onto the two 80 MHz channels for transmission. At the receiver, this mechanism is reversed, and the combined data from the two 80 MHz channels may be sent to the MAC layer.

In IEEE 802.11ax (described in IEEE P802.11ax/D8.0), high efficiency (HE) wireless STAs may support any of 20 MHz, 40 MHz, 80 MHz, and 160 MHz wide channels capable of transmission over any of 2.4 GHz, 5 GHz, and 6 GHz frequency bands using (e.g., both) orthogonal frequency-division multiple access (OFDMA) and multi-user multiple-input multiple-output (MU-MIMO) capabilities. OFDMA subcarrier modulation in HE STAs may include formats such as any of BPSK, QPSK, 16-QAM, 64-QAM, 256-QAM, and 1024-QAM. The evolution of IEEE 802.11 to extremely high throughput (EHT, or IEEE 802.11be) STAs may extend to having 320 MHz wide channels.

Sub 1 GHz modes of operation are supported by IEEE 802.11af, and IEEE 802.11ah. For these specifications the channel operating bandwidths, and the number of orthogonal frequency-division multiplexing (OFDM) subcarriers, are reduced relative to those used in IEEE 802.11n, and IEEE 802.11ac. IEEE 802.11af supports 5 MHz, 10 MHz and 20 MHz bandwidths in the television (TV) white space (TVWS) spectrum, and IEEE 802.11ah supports 1 MHz, 2 MHz, 4 MHz, 8 MHz, and 16 MHz bandwidths using non-TVWS spectrum. An example of use case for IEEE 802.11ah may include support for meter type control (MTC) devices in a macro coverage area. MTC devices may have limited capabilities with limited bandwidths and may require a very long battery life.

WLAN systems that may support multiple channels, and channel widths, such as IEEE 802.11n, IEEE 802.11ac, IEEE 802.11af, 802.11ah, 802.11ax, and IEEE 802.11be, may include a channel that may be referred to as the primary channel. The primary channel may have, for example, a bandwidth equal to the largest common operating bandwidth supported by (e.g., all) STAs in the BSS. The bandwidth of the primary channel may be limited by the STA that may support the smallest bandwidth operating mode in the BSS. In the example of IEEE 802.11ah, the primary channel may be 1 MHz wide if there are STAs (e.g. MTC type devices) that (e.g., only) support a 1 MHz mode (e.g., even) if the AP, and other STAs in the BSS, may support any of 2 MHz, 4 MHz, 8 MHz, 16 MHz, or other channel bandwidth operating modes. In an example, (e.g., all) carrier sensing, and NAV settings, may depend on the status of the primary channel; e.g., if the primary channel is busy, for example, due to a STA supporting (e.g., only) a 1 MHz operating mode being transmitting to the AP, then the (e.g., entire) available frequency bands may be considered busy e.g., even though majority of it stays idle and available.

The ultra-high reliability (UHR) study group is described herein.

The IEEE 802.11 ultra-high reliability (UHR), also known as IEEE 802.11bn study group was formed in September 2022. UHR is considered as the next major revision to IEEE 802.11 standards following 802.11be (or EHT), which is currently in the working group letter ballot stage. UHR may explore the possibility to improve reliability, support further reduced low latency traffic, further increase peak throughput, improve power saving capabilities, and improve efficiency of the IEEE 802.11 network over EHT.

Coordinated spatial reuse (Co-Sr) is described herein.

IEEE 802.11bn defines multi-AP coordinated spatial reuse (Co-SR) at TXOP-level with power control. IEEE 802.11bn may allow more efficient medium usage by concurrent transmissions of multiple APs using transmit power control. The Co-SR transmission may be initiated by an AP that may obtain a TXOP and may become the initiating AP (which may be referred to herein as sharing AP). The sharing AP may transmit a trigger frame to the participating AP (which may be referred to herein as shared AP) identified by the AP ID carried, for example, in the AID12 field of the user info field of the trigger frame to initiate the concurrent Co-SR transmission, as described in IEEE P802.11bn™/D0.1. IEEE 802.11bn limits the concurrent Co-SR transmission to the sharing AP and (e.g., only) one shared AP. A short interval after the trigger frame, the two APs may (e.g., simultaneously start to) transmit their respective data PPDUs during the concurrent Co-SR transmission. The duration of the two ensuing data PPDUs may be the same. In addition, IEEE 802.11bn limits both data PPDUs to be downlink (DL) single-user (SU) PPDUs and the maximum number of spatial streams transmitted by each AP in Co-SR to four. Moreover, IEEE 802.11bn defines two modes for the concurrent Co-SR transmission. In a first mode (referred to herein as Mode 1), at least one of the two data PPDUs during the concurrent Co-SR transmission may be an EHT PPDU. The format of the two data PPDUs may be a combination of UHR+EHT, EHT+UHR, or EHT+EHT. Both PPDUs may have the same L-SIG (non-high-throughput signal field) content. In a second mode (referred to as Mode 2), both data PPDUs may be UHR PPDUs that may have the same L-SIG and U-SIG contents. In Mode 2, the short interval between the end of the trigger frame and the two concurrent UHR data PPDUs may be a short interframe space (SIFS).

Embodiments are described herein with Co-SR transmissions as an example of an application where power measurement and reports may be applicable. Embodiments described herein are not limited to Co-SR transmissions. Power measurement and report methods described herein may be applicable to any kind of other applications, such as e.g., seamless roaming.

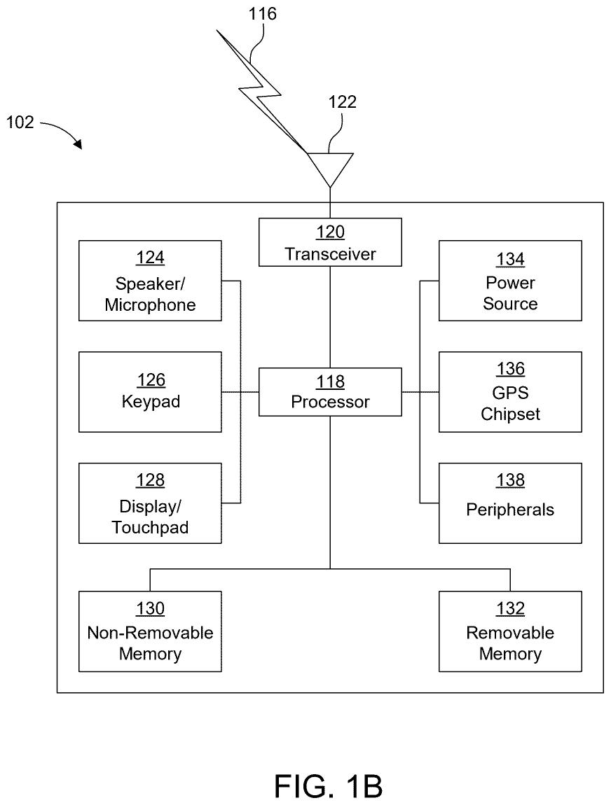

FIG. 2A is a diagram illustrating a transmission opportunity (TXOP) level Co-SR transmission scheme defined by IEEE 802.11bn.

FIG. 2B is a diagram illustrating the signal and interference paths between two concurrent Co-SR downlink data PPDU transmission pairs. In the illustrated examples, a first AP (referred to herein as AP1) 211 may be a sharing AP transmitting to a first station (referred to herein as STA1) 210 and a second AP (referred to herein as AP2) 221 may be a shared AP simultaneously transmitting to a second station (referred to herein as STA2) 220. In FIG. 2B, transmissions are illustrated as straight lines and interferences are illustrated as dotted lines. For the sake of clarity, embodiments are described herein with the examples of a DL Co-SR data PPDU transmission from AP₁, the sharing AP, to STA1 as the main data PPDU transmission, and a simultaneous DL data PPDU transmission from AP2, the shared AP, to STA2 as the secondary data PPDU transmission. Embodiments described herein are not limited to two simultaneous DL transmissions and are applicable to any number (e.g., greater than two) of simultaneous transmissions of any type (e.g., not limited to DL) between APs and STAs.

In embodiments described herein, “AP1” and “the sharing AP” may be used interchangeably, “AP2” and “the shared AP” may be used interchangeably, “STA1” and “the non-AP STA receiving the DL main Co-SR data PPDU from AP1” may be used interchangeably, and “STA2” and “the non-AP STA receiving the DL secondary Co-SR data PPDU from AP2” may be used interchangeably. In embodiments described herein, more than one shared AP may transmit DL PPDUs during the concurrent Co-SR DL data PPDU transmission. In embodiments described herein, AP(n+1) may refer to the nth shared AP and STA(n+1) may refer to the corresponding recipient of its Co-SR DL PPDU, e.g., AP3 and STA3, AP4 and STA4, etc.

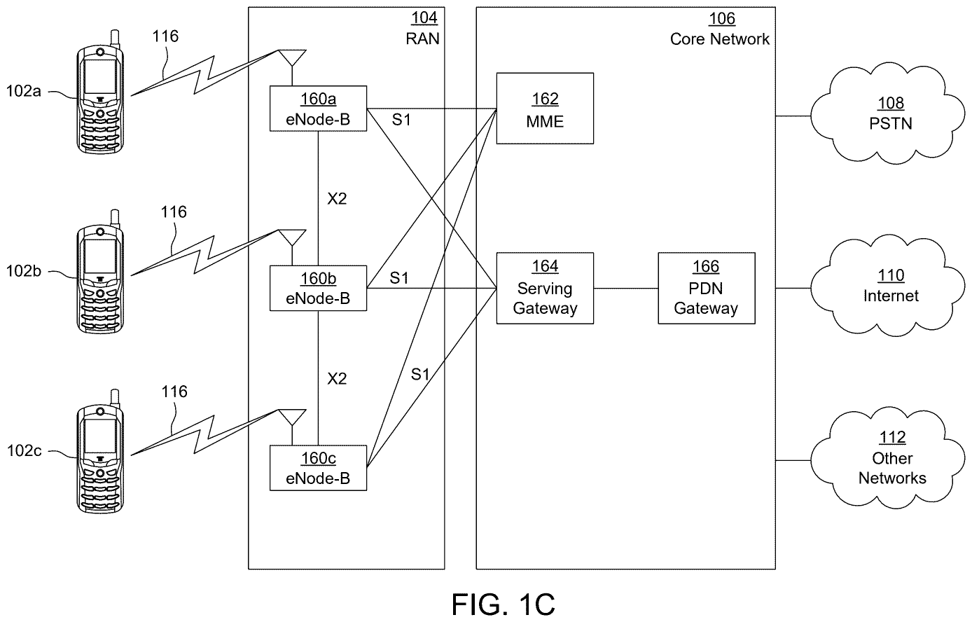

FIG. 3 is a diagram illustrating an example of Co-SR protocol.

In an example, as shown at 31, an AP may announce (e.g., transmit announcement information indicating) any of its Co-SR capabilities and enablement through some elements in management frames such as any of a beacon frame, an action frame, an association response frame, a reassociation response frame, and a probe response frame. As shown at 32, multiple neighboring APs with Co-SR capabilities may negotiate with each other to establish a multi-AP coordination (MAPC) agreement to enable Co-SR. As shown at 33, a non-AP STA associated with an AP that may enable Co-SR, may listen and measure any of a receive signal strength indicator (RSSI), a path loss, a channel quality indicator (CQI), a signal to noise ratio (SNR), or any other signal strength or power related parameters from its associated AP and neighboring APs, and may send the measurements to its associated AP. As shown at 34, multiple APs that may be in an MAPC agreement for Co-SR may exchange their in-BSS measurement reports and may form coordination decisions (e.g., any of (i) with which AP to share a TXOP using Co-SR, (ii) whether to accept to share a TXOP using Co-SR, (iii) which receiving STA to select), based on the pooled measurement reports. Although boxes shown at 32, 33, and 34 are illustrated as sequential in FIG. 3, embodiments described herein are not limited to the illustrated sequence order. For example, power measurement and report shown at 33 may (e.g., also) take place independently of the flow and may influence any of (i) the Co-SR MAPC agreement negotiation stage shown at 32 and (ii) the multi-AP information exchange and coordination stage shown at 34. In another example, power measurement and report shown at 33 may be interlaced/included within the operations shown at 32 and 34. As shown at 35, when an AP obtains a TXOP and decides (e.g., determines) to be a sharing AP, it may send out a Co-SR triggering frame to signal (e.g., indicate) one or more other shared APs to transmit data PPDUs in the following Co-SR concurrent transmission slot. As shown at 36, the sharing AP and one or more shared APs may perform concurrent Co-SR transmissions (using the same resources). As shown at 37, the recipient STAs of the data PPDUs may send acknowledgments (ACKs) that may be to be received by their respective APs.

A shared AP may control the transmit power during the concurrent Co-SR transmission so that it may be causing tolerable interference to any of the STA that may be receiving from the sharing AP and other STAs that may be receiving from other shared APs. In an example, the transmit power level used by the shared AP may be set by itself. In another example, the transmit power level used by the shared AP may be specified (e.g., indicated) by the sharing AP. In any case, the transmit power (e.g., if in dBm) of the shared AP may be controlled to be no more than (e.g., to not exceed) the tolerable interference level at the STA that may be receiving from the sharing AP (e.g., if also in dBm) plus the path loss from the shared AP to the STA (e.g., if in dB). The sharing AP may or may not control its transmit power. If the sharing AP controls its transmit power, the sharing AP may consider (e.g., only) causing tolerable interference to the STAs receiving from the shared APs.

The pair-wise path loss information exchange between (e.g., all) the APs and non-AP STAs may enable power control in Co-SR. The tolerable interference level at a non-AP STA for receiving transmission from its associated AP may be determined by any of the transmit power of the AP, the modulation and coding schemes used for the transmission, the path loss from the AP to the STA, and a link margin for operations. The inference level at a non-AP STA caused by an unassociated (e.g., overlapping BSS (OBSS)) AP may be related to the transmit power of the OBSS AP and the path loss from the OBSS AP to the non-AP STA. Besides pathloss, any of an RSSI, an SNR, a received channel power indicator (RCPI), a received signal-to-noise indicator (RSNI) and a channel quality indicator (CQI) or any other signal strength related values measured on transmissions from an OBSS AP at a non-AP STA may be useful information for Co-SR transmit (TX) power control. Some embodiments are described with an RSSI as an example of power measurement. These embodiments are not limited to RSSI, and any power measurement may be applicable to any embodiment described herein. Embodiments are described herein by referring to any of these power-related measurements as “power measurements” collectively, or simply “measurements”. Embodiments described herein are not limited to pathloss, RSSI, SNR, RCPI, CQI, RSNI, and any signal strength/power related values measured on transmissions from an OBSS AP at a non-AP STA may be applicable to embodiments described herein. In an example, if any of the RSSI, SNR, RCPI, RSNI, CQI fails to satisfy a power condition (e.g., is below a certain threshold), or the pathloss satisfy a path loss condition (e.g., is above a certain threshold), e.g., the non-AP STA may not be able to “hear” an OBSS AP, the non-AP STA may report any of an indication and a (e.g., special) value indicating that the non-AP STA may not be able to “hear” the OBSS AP as power measurement.

If the OBSS AP's transmit power is known, the path loss may be determined by the difference between the transmit power and the RSSI. In an example, absolute power values may be calculated for Co-SR TX power control of the OBSS AP based on the path loss and a target tolerable interference level. If the OBSS AP's transmit power is unknown, any of delta power values and power ratios relative to a reference transmit power e.g., used for RSSI measurement in one or more previous transmission may be calculated for Co-SR TX power control of the OBSS AP based on the RSSI and the target tolerable interference level.

In an example, the power measurement information of AP-to-non-AP-STA pairs may be obtained during the measurement and report stage, where non-AP STAs may perform measurements on (e.g., both) the associated AP and OBSS APs and may report the results to their associated APs.

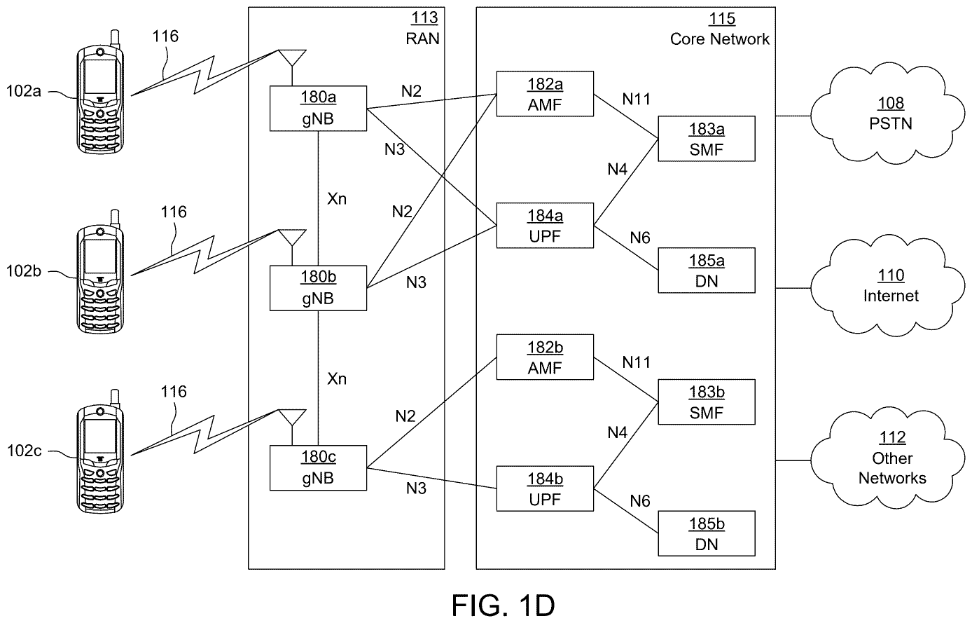

FIG. 4 is a diagram illustrating an example of power measurement and report stage of Co-SR, where non-AP STAs associated with a first AP (referred to as AP1) may perform power measurements through measurement frames 41, 42, 43 sent by AP1 and OBSS APs and may report the measurements to AP1 in measurement reports 44, 45.

In an example, the power measurement information of non-AP-STA-to-AP pairs (reverse direction of AP-to-non-AP-STA direction in FIG. 4) may be useful for Co-SR in terms of determining the ACK schemes responding to the concurrent Co-SR DL PPDUs. Measurement reports may be exchanged between the APs during the multi-AP information exchange and coordination stage of the Co-SR protocol. In an example, the transmit power control may be signaled through any of an absolute power value and a delta power value (or a power ratio) with respect to a reference power. Any signaling and frame sequence of the measurement and report stage that may enable Co-SR transmit power control may be applicable to embodiments described herein.

For the sake of clarity, embodiments are described herein with one shared AP. Embodiments described herein are not limited to a single shared AP. Any number of shared APs may be applicable to embodiments described herein. The same applies to the number of non-AP STAs receiving the Co-SR main or secondary data PPDU transmissions. Any number of receiving STAs of Co-SR concurrent data PPDU transmissions may be applicable to embodiments described herein.

Measurement using any of beacon frames and measurement pilot frames are described herein.

Means of measurement are described herein.

The measurement frames may comprise any of beacon frames and measurement pilot frames as described in IEEE P802.11-REVme™/D7.0. APs may periodically transmit beacon frames to advertise network, timing, and traffic information. APs may have the option of transmitting the measurement pilot frame, a smaller management frame with a subset of the information provided in a beacon frame and transmitted more often than a beacon frame, to assist STAs with scanning. To provide more frequent Co-SR power measurement opportunities, APs may transmit (e.g., both) beacon frames and measurement pilot frames that may contain AP identifiers such as any of BSSIDs and AP IDs related to MAPC transmission. Non-AP STAs may scan the beacon frames periodically transmitted by APs for various purposes such as any of network discovery, timing synchronization, and traffic indication. Non-AP STAs that may have the Co-SR capability enabled and/or that may be active for Co-SR participation may (e.g., actively) measure the received signal strength of any of the beacon frames and the measurement pilot frames and may store the power measurement (e.g., RSSI) results along with the identifiers of the transmitting APs. If any of the beacon frame and the measurement pilot frame is received using multiple receive chains, the measured power measurement (e.g., RSSI) may be averaged in linear domain over multiple (e.g., all) active receive chains. The power measurement (e.g., RSSI) result may be reported in dBm. The power measurement (e.g., RSSI) measured from an AP may be averaged over multiple beacon frames and/or measurement pilot frames within a time period using e.g., a smoothing function.

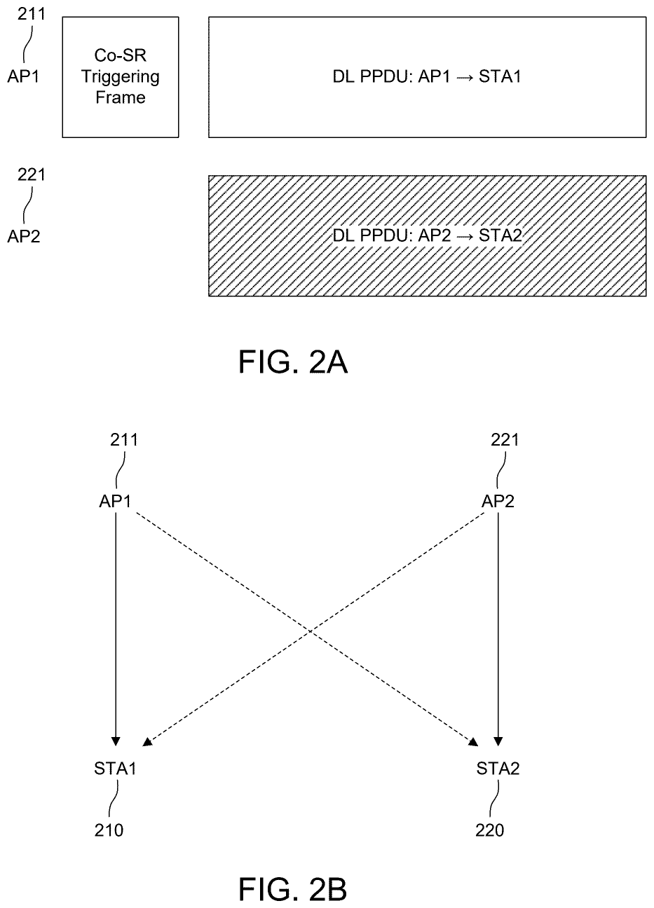

FIG. 5 is a diagram illustrating the transmit power control (TPC) report element format used in IEEE P802.11-REVme™/D7.0.

In an example method, to facilitate the measurement of the path loss from APs to STAs, the APs may explicitly indicate the TX power used for the transmission of any of the beacon frame and the measurement pilot frame by including a TPC report element in them. The TPC report element included in any of the beacon frame and the measurement pilot frame may be as defined in IEEE P802.11-REVme™/D7.0 and shown in FIG. 5. The transmit power field may be used to indicate the TX power of any of the beacon and the measurement pilot frames. The link margin field may be set to zero. Based on receiving such a beacon or measurement pilot frame (e.g., including a TPC report element), a non-AP STA may decode the frame to obtain the TX power from the transmit power field. The path loss in dB from the transmitting AP of the frame to the non-AP STA may be calculated as the difference between the TX power in dBm and the measured RSSI value in dBm. The path loss measurement may (e.g., also) be averaged over multiple beacon frames and/or measurement pilot frames within a time period using e.g., a smoothing function. A non-AP STA may include information such as any of the identifier (e.g., any of BSSID, AP ID) of the transmitting AP, the RSSI value, and the pathloss value in its measurement report on the AP.

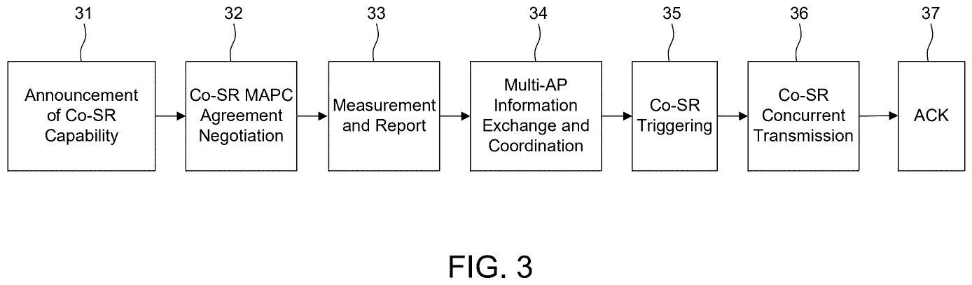

FIG. 6 is a diagram illustrating an example method for power measurement on beacon/measurement pilot frames with explicit TX power indication.

As shown at 61, a first station (e.g., referred to as STA1), a non-AP STA associated with AP1, may perform power measurement on any of beacon frames and measurement pilot frames sent by AP2 with an explicit TX power indication.

STA1 may perform measurements based on any of the following conditions being satisfied.

In an example, a condition may be satisfied if the received power of the receiving frames is greater than a predefined threshold, e.g., any of clear channel assessment (CCA) threshold for energy detection, CCA threshold for packet detection, a newly defined CCA threshold etc.

In an example, a condition may be satisfied if the transmit address field of the receiving frame corresponds to AP2 (e.g., the AP that may have set up the MAPC agreement with AP1, STA1's associated AP).

In an example, a condition may be satisfied if the transmit address field of the receiving frame corresponds to an AP that may belong to the same multiple BSSID set as AP2, where at least one AP in the same multiple BSSID, e.g. AP2, may have set up the MAPC agreement with AP1, STA1's associated AP.

In an example, a condition may be satisfied if the receiving frame is any of a beacon frame, a measurement pilot frame, and a frame which may be used for MAP related measurement (e.g., measurement used for Co-SR, seamless roaming, etc.).

In an example, a condition may be satisfied if the transmit power of the transmitter is explicitly included in the receiving frame.

As shown at 61, STA1 may calculate the pathloss from AP2 to STA1 based on the TX power of AP2 and its received power (e.g., RSSI) from AP2. STA1 may (e.g., also) calculate AP2's (e.g., maximum, upper limit) TX power that may cause (e.g., maximum, upper limit) tolerable interference level at STA1 for one or more modulation and coding schemes (MCSs). STA1 may (e.g., also) calculate AP2's power adjustment to cause (e.g., maximum, upper limit) tolerable interference level at STA1 for one or more MCSs.

As shown at 62, STA1 may transmit a power measurement report of AP1. Any of the pathloss and the suggested AP2 TX power or power adjustment may be a part of the power measurement report that STA1 may send to AP1.

As shown at 63, AP1 may calculate an absolute TX power limit for AP2 to not be exceeded during the concurrent transmissions of AP1 to STA1 and AP2 to some of its non-AP STA. AP1 may send power information to AP2 to indicate the calculated TX power limit for AP2.

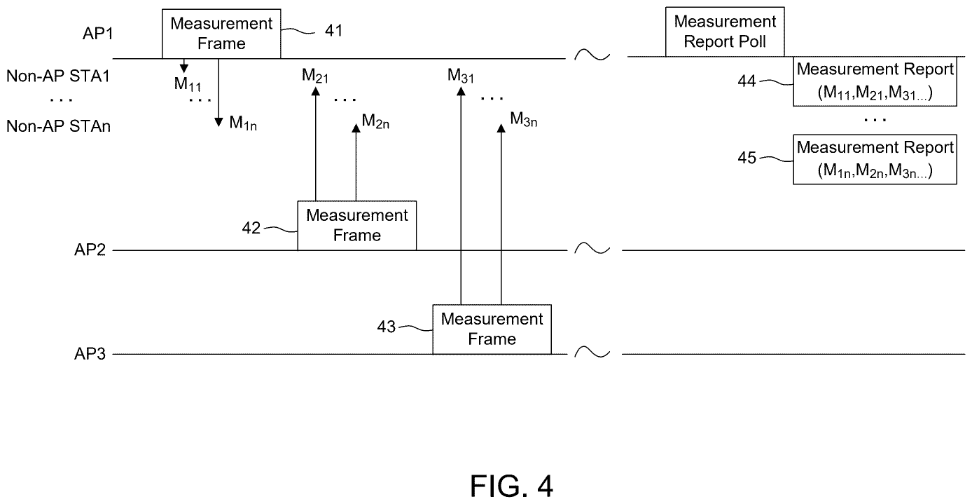

FIG. 7 is a diagram illustrating an example method for power measurement on beacon/measurement pilot frames with a default TX power. As shown at 71, to facilitate the measurement of the path loss from APs to STAs, the APs may agree on a default TX power to be used for any of their beacon frames and measurement pilot frames. In an example, the agreement may be signaled during the MAPC agreement negotiation stage so that APs may know each other's TX power used for the transmission of any of their beacon frames and measurement pilot frames. For example, any of the APs may send information to any other APs indicating the default TX power value (e.g., level). As shown at 72, a non-AP STA may report to its associated AP, (e.g., AP1), measurement information such as e.g., any of the identifier (e.g., BSSID) of a transmitting AP (e.g., AP2), and the power measurement (e.g., RSSI) value that may have been measured on any of the beacon frames and the measurement pilot frames sent by AP2. As shown at 73, based on AP1 knowing AP2's TX power of any of the beacon frames and the measurement pilot frames (as shown at 74), AP1 may calculate the pathloss (e.g., in dB) from AP2 to the non-AP STA as the difference between AP2's TX power and the reported power measurement (e.g., RSSI) value (e.g., both in the unit of dBm). In an example, AP1 may notify AP2 with (e.g., send a transmission to AP2 including/indicating) an absolute TX power value to use during TX power control on AP2. In another example, AP1 may determine to notify AP2 with (e.g., send a transmission to AP2 including/indicating) any of a delta power or a power ratio adjustment using the default TX power as a reference to apply those adjustments for AP2's TX power control. Based on the power measurement (e.g., RSSI) of AP2, STA1 may (e.g., also) calculate AP2's power adjustment to cause a (e.g., maximum, upper limit) tolerable interference level at STA1 for one or more MCSs, with the TX power used by AP2 to send any of the beacon frame and the measurement pilot frame as a TX power reference. The suggested AP2 TX power adjustment may be a part of the power measurement report that may be sent by STA1 to AP1.

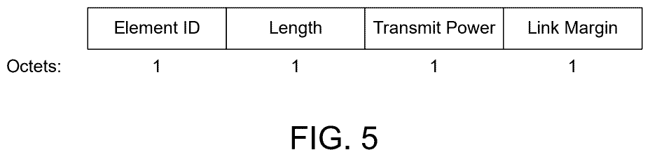

FIG. 8 is a diagram illustrating an example method for power measurement on beacon/measurement pilot frames with a TX power associated with a timestamp. As shown at 82, a non-AP STA may report to its associated AP (e.g., AP1), measurement information indicating e.g., any of the identifier (e.g., any of BSSID, AP ID) of a transmitting AP (e.g., AP2), the power measurement (e.g., RSSI) value measured on any of the beacon frames and the measurement pilot frames sent by AP2, along with any of a timestamp and a measurement token to indicate when the RSSI measurement may have been done. In an example, the indicated timestamp may be the timestamp field decoded from any of the beacon frames and the measurement pilot frames. In another example, the indicated timestamp may be a partial timestamp which may be a certain number of least or most significant bits of the timestamp field. The measurement token may be sent by AP1 (e.g., the associated AP) when requesting the non-AP STA to perform measurements. The AP1 may link (e.g., associate) the measurement token to a timestamp. When (e.g., later) AP1 wants AP2 to adjust its TX power during the Co-SR transmission stage, as shown at 83, AP1 may indicate any of a delta power adjustment value and a ratio power adjustment value along with a (e.g., partial) timestamp to AP2. As shown at 84, AP2 may use the TX power of its beacon and/or measurement pilot frames associated with the timestamp as a reference power to apply any of the delta and ratio adjustment value to obtain the (e.g., new) adjusted TX power requested by AP1. In an example, based on the RSSI of AP2, STA1 may (e.g., also) calculate AP2's power adjustment to cause (e.g., maximum, upper limit) tolerable interference level at STA1 for one or more MCSs, with the TX power used by AP2 to send any of the beacon frames and the measurement pilot frame as a TX power reference. The suggested AP2 TX power adjustment may be a part of the power measurement report that may be sent by STA1 to AP1.

Measurement reporting is described herein.

There may be various methods for an AP to request its associated non-AP STA to report power measurements on its associated AP and neighboring APs back to its associated AP.

In a first example method, an AP participating in Co-SR may request an associated non-AP STA to gather information regarding the neighborhood by sending a beacon request frame, which may comprise any of an action frame such as any of a spectrum measurement request frame, a radio measurement request frame, a link measurement request frame, and a neighbor report request frame. In an example, the beacon request frame may request the non-AP STA to gather measurement information of APs matching a particular (e.g., indicated) identifier (e.g., any of BSSID and/or SSID, AP ID). In another example, the beacon request frame may use (e.g., include/indicate) a wildcard BSSID or AP ID (e.g., the ID field bits may be to one) to request measurements on all neighboring APs that the non-AP STA can hear. In an example, the AP may request the non-AP STA to generate a report that may (e.g., only) be for the channels on which the requesting AP may be operating with Co-SR. In another example, the AP may request the non-AP STA to generate a report on (e.g., all) channels it may switch to and/or continue with Co-SR operations. The requesting AP may request the non-AP STA to report information of neighboring APs associated with (e.g., useful for) Co-SR, including (and not limited to) any of BSSID, BSS color, SSID, AP ID, RSSI, pathloss, channel number, RCPI, RSNI, timestamp, measurement token, measurement start time, measurement duration, etc. The non-AP STA may send requested information back to the AP through, for example, a beacon report frame that may contain the measurement report field corresponding to any of a beacon report as described in IEEE P802.11-REVme™/D7.0 or a modified version of the beacon report. The beacon report frame may comprise an action frame such as e.g., any of a spectrum measurement report frame, a radio measurement report frame, a link measurement report frame, and a neighbor report response frame. In an example, a beacon report responding to a beacon request may be transmitted over a set of one or more frames. In another example, a single frame may contain the beacon report for several beacon requests. In an example, a single request may solicit multiple beacon reports over a period of time.

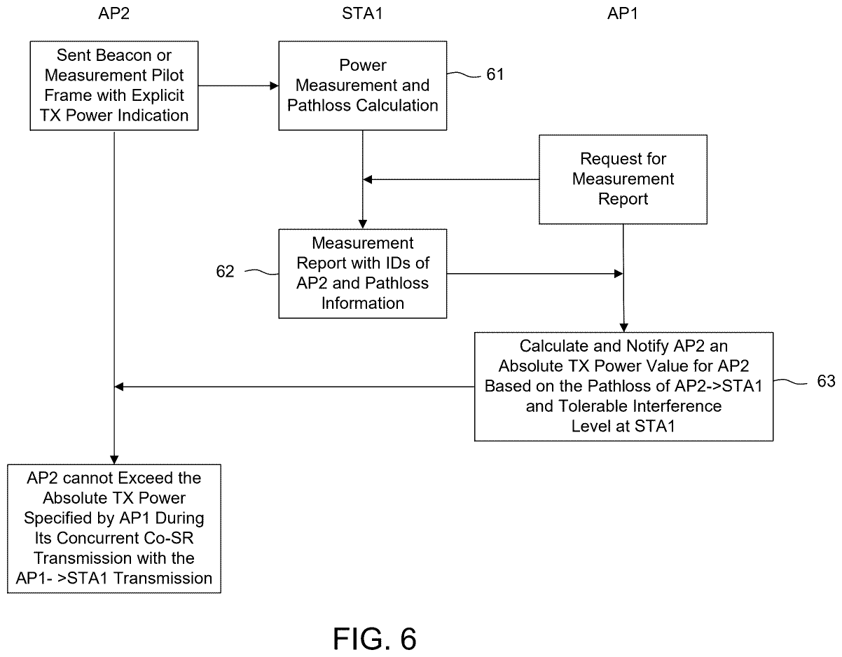

FIG. 9 is a diagram illustrating an example of a simplified measurement report field for Co-SR beacon report. In one example, the measurement report field corresponding to a beacon report may take a simplified format as shown in FIG. 9. The number of reports field 91 may indicate how many reports may be included in this report field. One report 92 may comprise a BSSID/AP ID field 921, a measurement start timestamp field 922, a measurement type field 923, and a measurement value field 924. The BSSID/AP ID field 921 may identify the AP being measured. The measurement start timestamp field 922 may identify when the measurement may be done and may also contain the measurement duration information. The measurement type field 923 may indicate whether RSSI or pathloss or RCPI or RSNI or other power measurement value may be reported in the measurement value field 924.

In a second example method, a non-AP STA enabled for participating in Co-SR may gather any of the above-described power measurement information of any of its associated AP and neighboring APs associated with (e.g., useful for) Co-SR e.g., without an explicit request and may periodically send gathered information to its associated AP through any of the above-described beacon report action frames in an unsolicited manner.

In a third example method, a non-AP STA enabled for participating in Co-SR may gather any of the above-described power measurement information of any of its associated AP and neighboring APs associated with (e.g., useful for) Co-SR e.g., without an explicit request, and may report such information to its associated AP (e.g., only) once requested.

In one example, an AP may use the beacon request action frames to solicit reports, and a non-AP STA may respond with the beacon report action frames as described herein.

In another example, an AP may use a trigger frame to solicit power measurement information from its associated non-AP STAs. The trigger frame may comprise any of a basic trigger frame, a multi-user request-to-send (MU-RTS) trigger frame, a buffer status report poll (BSRP) trigger frame, a BSRP GI3 trigger frame (BSRP trigger frame with the guard interval (GI) and HE/UHR-LTF type subfield set to 3), a multi-user block ack request (MU-BAR) trigger frame, a beamforming report poll (BFRP) trigger frame (or their new variants), and a (e.g., new) trigger frame variant. The trigger frame may contain multiple user info fields to identify multiple non-AP STAs through the AID12 subfield and to specify (e.g. indicate) in the resource unit (RU) allocation field the resource units (RUs) to be used respectively in the response frame. Any of the trigger dependent common info field, the trigger dependent user info field, and the special user info field may be used to carry more requirement information about the AP's request, such as any of the BSSID, the BSS color, the SSID, and the AP ID of the OBSS AP on which measurements may be reported, the measurement type (any o RSSI, pathloss, RCPI, RSNI, CQI, SNR, etc.), the channel number, timestamp, measurement token, measurement start time, measurement duration, etc.

The non-AP STAs may respond to the trigger frame with (e.g., by transmitting) a trigger-based (TB) PPDU that may contain the power measurement information on multiple neighboring APs. Power measurement information may be carried in a frame body format similar to the beacon report action frames described herein, or using the simplified format shown in FIG. 9. In an example, the responding frame may comprise a multi-STA BlockAck frame or any of its variants, where a (e.g., each) per association identifier (AID) traffic identifier (TID) AID TID info subfield may be/include a power measurement report on an OBSS AP. In a (e.g., each) per AID TID info subfield, the AID11 subfield may be used to identify the OBSS AP to be reported on. The BlockAck bitmap field may be repurposed to contain/indicate the power measurement information on the OBSS AP.

The non-AP STAs may respond with (e.g., by transmitting) HE/EHT/UHR action frames such as the HE/EHT/UHR compressed beamforming/CQI frames, which may contain any of full-bandwidth and partial-bandwidth CQI reports.

The non-AP STAs may respond in their subsequent frames to their AP with a new control subfield variant of an A-Control subfield in the HT control field, which may be in the frame control field of MAC frames. There are twenty-six bits available for a simplified power measurement report on one or more OBSS APs.

The above-described power measurement through any of beacon frames and measurement pilot frames and the subsequent report procedure may be applicable to seamless roaming, a feature being developed in IEEE 802.11bn where non-AP multi-link devices (MLDs) may obtain the RSSI measurement to the neighboring AP MLDs to determine the target AP MLD to switch to. With power measurements from multiple neighboring OBSS AP MLDs, a non-AP STA may perform AP selection to choose (e.g. determine) the next AP MLD it may roam to and request to be associated with based on one or more selection criteria such as any of (i) the neighboring AP having the minimum (e.g., lowest) pathloss to the non-AP STA, (ii) the neighboring AP having the maximum (e.g., highest) RSSI at the non-AP STA, (iii) the neighboring AP having a pathloss to the non-AP STA below a (e.g., certain) threshold, (iv) the neighboring AP having the RSSI at the non-AP STA larger than a threshold plus, e.g., other considerations. The non-AP STA may also report such power measurements to its current associated AP, and the current AP may select the next AP MLD for the non-AP STA to switch to, based on similar criteria as described above. In an example, the current AP may send information to the non-AP STA, indicating the selected next AP MLD to switch to. With the target AP MLD being determined, the current AP may start the roaming preparation and execution procedures, and may transfer (e.g., transmit information including/indicating) any of context and DL data related to the non-AP STA to the target AP MLD.

Measurement through sounding sequences is described herein.

In embodiments described herein, the terms null data packet (NDP) and null data PPDU, collectively NDP may be used interchangeably.

In an example, the measurement frames may be any of null data PPDU announcement (NDPA) and null data PPDU (NDP) frame sequences.

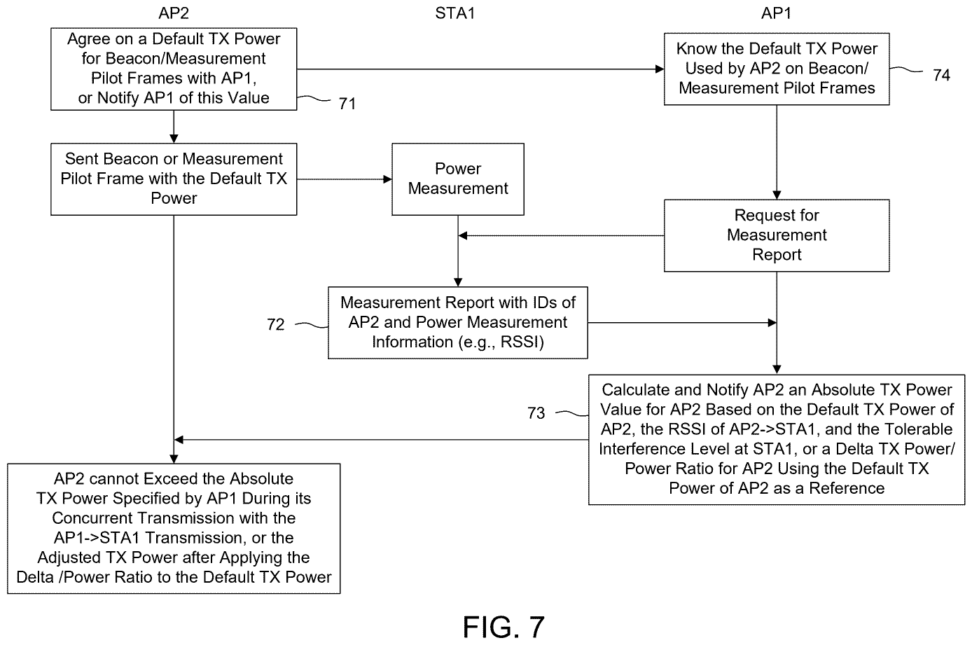

FIG. 10 is a diagram illustrating an ultra-high reliability (UHR) sequential NDP sounding sequence initiated from AP1 to sound on (e.g., both) AP1 and AP2.

In one example method, the measurement and reporting sequence may follow the UHR sequential NDP sounding sequence initiated by an AP as illustrated in FIG. 10. The sounding sequence may be used for any of: (i) coordinated beamforming (Co-BF) purpose, (ii) Co-SR purpose, and (iii) piggybacking Co-SR measurement and reporting onto Co-BF sounding measurement and reporting. For the in-BSS measurements, an initiating AP (referred to as AP1) may send an NDPA frame 1001 to notify its associated non-AP STAs the sounding NDP frame 1002 that AP1 may transmit a short interframe space (SIFS) after the end of the NDPA frame 1001. After its associated non-AP STAs may have conducted measurements on the NDP frame 1002, AP1 may send a trigger frame 1003 to request them to report measurements back in a report frame 1004. For the cross-BSS measurement, similarly, AP1 may send an NDPA frame 1011 first to notify its associated non-AP STAs the incoming sounding NDP frame 1012 that may be transmitted by an OBSS AP. After non-AP STAs may have conducted measurements on the OBSS AP's NDP frame 1012, AP1 may send a trigger frame 1013 to request them to report measurements back in a report frame 1014.

In the sequential sounding sequence, the NDPA frame 1001 1011 may indicate an identifier of the AP that may transmit the following NDP frame 1002 1012, which may be any of a BSSID, an SSID, a BSS color, an AP ID associated with a general or Co-SR MAPC agreement, an AP ID along with an identifier of the MAPC agreement, etc. Neighboring APs of AP1 that may participate in Co-SR may monitor NDPA frames 1011 to determine whether they may be transmitting the following NDP frame 1012 and whether it is a sequential sounding sequence or others.

In the sequential sounding sequence, the NDPA frame 1001 1011 may indicate one or more non-AP STAs associated with AP1 to conduct measurements on the following NDP frame 1002 1012. The AID11 subfield of the STA info field may contain identifiers of individual STAs or a special identifier that may invoke (e.g., all) non-AP STAs of AP1 that may participate in Co-SR.

In the sequential sounding sequence, the NDPA frame 1001 1011 may be modified to have/include bits to indicate the measurement type: e.g., any of compressed beamforming matrices for Co-BF, CQI/RSSI/pathloss for Co-SR, a combination of measurement types.

In the sequential sounding sequence, the NDPA frame 1001 1011 may (e.g., also) be modified to have a TX power indication on the subsequent NDP frame. Any of the initiating AP, AP1, and the OBSS AP may use the specified/indicated TX power to transmit the NDP frames. The non-AP STAs may decode the TX power information to calculate the pathloss by comparing (e.g. determining the difference between) the measured RSSI and the TX power. If AP1 has the pathloss from an OBSS AP (e.g., AP2) to one of its non-AP STA (e.g., STA1), then AP1 may determine an absolute TX power level P₂ for AP2 based on the pathloss and a tolerable interference level at STA1. AP2 may keep its TX power level no larger than the specified/indicated P₂ during its concurrent Co-SR transmission with the transmission from AP1 to STA1.

In the sequential sounding sequence, if no TX power indication is given in any of the NDPA and NDP frame, the OBSS AP may keep track of what TX power it may have used for the NDP frame during the sounding process with AP1 and its STAs. Later AP1 may compare a tolerable interference level at STA1 with the reported or derived RSSI value at STA1 from AP2 and may indicate to AP2 how much power adjustment it may apply to its concurrent Co-SR transmission using AP2's NDP frame TX power as a reference.

In the sequential sounding sequence, AP1 may use a BFRP trigger frame to solicit the CQI/RSSI/pathloss report from one or more of its non-AP STAs as done for the EHT TB sounding. The EHT compressed beamforming/CQI report field contained in the solicited compressed beamforming/CQI frame may be modified to carry information such as any of the RSSI/pathloss report and the identifier of the measured AP associated with the measurement.

In the sequential sounding sequence, AP1 may (e.g., also) replace the BFRP trigger frame with other trigger frames such as e.g., any of a basic trigger frame, an MU-RTS trigger frame, a BSRP trigger frame, a BSRP GI3 trigger frame, an MU-BAR trigger frame, or any of their new variants, or a new trigger frame variant as described herein when using beacon/measurement pilot frames for measurement. Similarly, the responding report frame from non-AP STAs may respond to the trigger frame with any of a compressed beamforming/CQI action frame, a trigger-based (TB) PPDU, beacon report action frames, a multi-STA BlockAck frame or any of its variant, or frames with a new control subfield variant of an A-Control subfield in the HT control field that may have twenty-six bits to carry measurement information.

In an example, these frame sequences may happen above the TXOP level, and the measurement and reported results may be valid and aid the Co-SR TX power control decisions over multiple TXOPs. In an example, these frame sequences may happen within a TXOP, and the measurement and reported results may influence the Co-SR TX power control decisions within this specific TXOP.

In a second example method, the measurement and reporting sequence may skip the in-BSS EHT sounding portion and (e.g., only) use the cross-BSS UHR sounding portion of the UHR sequential NDP sounding sequence (shown in FIG. 10) to obtain the power measurement of the non-AP STAs from the OBSS APs. The in-BSS measurements may be conducted and reported through any of the methods described herein based on beacon/beacon request/beacon report frames. The in-BSS measurements may be conducted by piggybacking to the normal beamforming sounding sequence or based on the link-adaptation procedure through PPDUs between the AP and non-AP STAs.

In a third example method, the measurement and reporting sequence may follow a UHR joint NDP sounding sequence initiated by an AP.

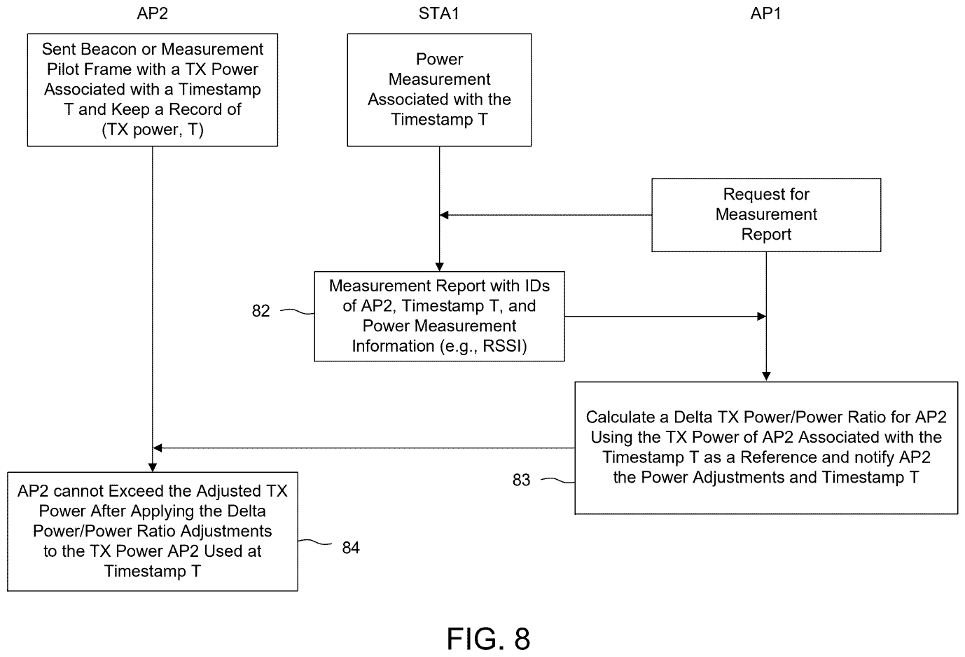

FIG. 11 is a diagram illustrating a UHR joint sounding sequence initiated from AP1 to sound on (e.g., both) AP1 and AP2, where the sounding sequence may be used for any of: (i) coordinated beamforming (Co-BF) purpose, (ii) Co-SR purpose, and (iii) piggybacking Co-SR measurement and reporting onto Co-BF sounding measurement and reporting. The initiating AP (referred to as AP1) may send an NDPA frame 1101 to notify its associated non-AP STAs the sounding NDP frames 1102 1112 that (e.g., both) AP1 and AP2 may (e.g., simultaneously, concurrently) transmit SIFS after the end of the NDPA frame 1101. After its associated non-AP STAs may have conducted measurements on the NDP frames 1102 1112, AP1 may send a trigger frame 1103 to request them to report measurements back in a report frame 1104. For the joint sounding sequence described herein based on FIG. 11, any features, characteristics or variant described herein for the sequential sounding based on FIG. 10 may be applicable. One or more changes/additional features may be specific to the joint sounding sequence, as described herein.

In an example, the NDPA frame 1101 may indicate an identifier for (e.g., both) AP1 and AP2 that may transmit the following NDP frame 1102 1112, which may include any of a BSSID, SSID, BSS color, AP ID associated with a general or Co-SR MAPC agreement, an AP ID along with an identifier of the MAPC agreement, etc. Neighboring APs of AP1 that may participate in Co-SR may monitor NDPA frames 1101 to determine whether they may be transmitting the following NDP frame 1112 and whether it may be a joint sounding sequence or others.

In an example, the NDPA frame 1101 may assign/indicate any of the starting spatial stream index and the number of spatial streams for (e.g., both) the initiating AP and OBSS APs, or at least for OBSS APs. The non-AP STA that may conduct measurements may take the total received power strength across receiving chains and may calculate the power measurement for an (e.g., each) AP proportional to the total signal strength across their respective spatial streams.

Measurement though TXOP level sequences are described herein.

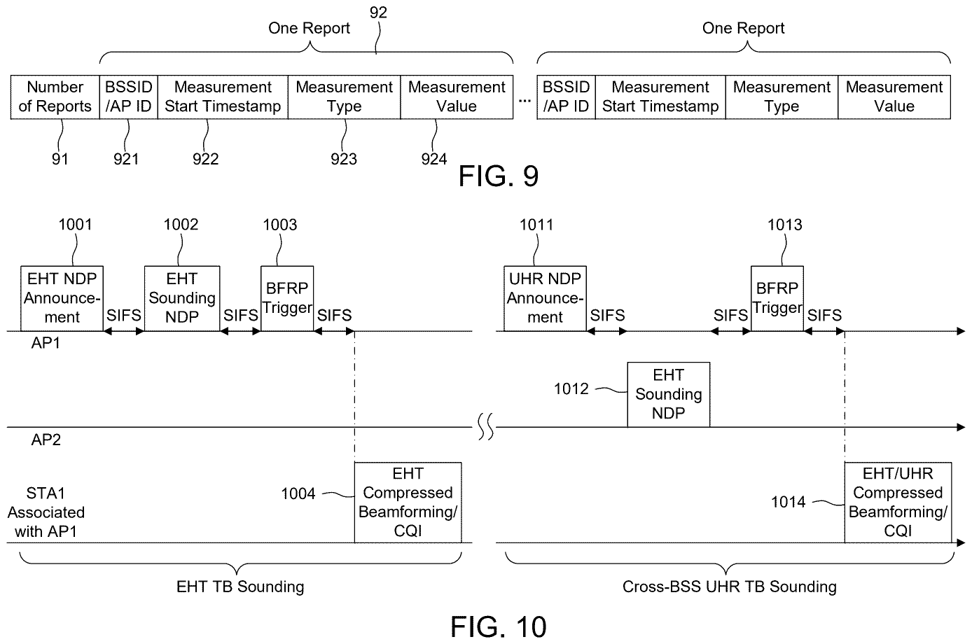

FIG. 12 is a diagram illustrating an example invite/response and initial control frame/initial control response frame exchange sequence for Co-SR.

The measurement frames may comprise a series of TXOP level frame sequences exchanged between the APs and non-AP STAs (e.g., right) before the concurrent Co-SR data transmissions. The frame sequence may contain any of an invite frame 1201 sent by the TXOP owner, a response frame 1202, one or more initial control frames (ICF) 1203 1205, one or more initial control response (ICR) frames 1204 1206, a Co-SR trigger frame 1207, at least two concurrent Co-SR DL data PPDUs 1208 1209, and at least two acknowledge (ACK) frames 1210 1211.

The invite frame 1201 may be sent by the TXOP owner AP1 (e.g., the sharing AP).

In an example, the invite frame 1201 may contain/indicate any of (i) an indication of the MAC frame type (e.g., indicate the invite frame 1201 being a Co-SR invite frame), (ii) an identifier of AP2, an OBSS AP that may be invited to share a portion of the TXOP via Co-SR with AP1, and (iii) an identifier of STA1, a non-AP STA that AP1 may have queued DL traffic for. AP1 may indicate (e.g., in the invite frame 1201) the priority of its queue traffic to STA1.

In an example, AP1 may set (e.g., include/indicate in the invite frame 1201) a TX power to be used by AP2 in any of the following response frame 1202 and the following initial control frame (ICF) 1205. AP2 and STA1 may monitor and decode the invite frame 1201 to obtain the above-described information.

In an example, AP1 may indicate (in the invite frame 1201) its TX power used for the invite frame 1201 and may keep the same TX power for the later frames in the Co-SR sequence.

In an example, STA1, if identified, may conduct power measurements on AP1 to obtain any of RSSI, pathloss, and CQI information of AP1. If AP1 indicates the TX power of the invite frame 1201, it may be used to obtain the pathloss from AP1 to STA1.

The invite frame 1201 may be a trigger frame, such as e.g., any of a basic trigger frame, an MU-RTS trigger frame, a BFRP trigger frame, a BSRP trigger frame, a BSRP GI3 trigger frame, an MU-BAR trigger frame, or any of their new variants, or a new trigger frame variant. The identifiers of AP1 and STA1 may be carried/indicated in the AID12 field of a user info field or a special user info field. The TX power specified/indicated for AP2 may be carried in any of a user info field, a special user info field, or their trigger dependent user info field.

The response frame 1202 may be sent by AP2 (e.g., the shared AP).

In an example, AP2 may indicate (e.g., in the response frame 1202) the MAC frame type (e.g., indicating the response frame 1202 being a Co-SR response frame) and may respond/indicate in the response frame 1202 with its availability for participating in the Co-SR transmission with AP1 in this TXOP. The response/indication may include/indicate any of available/accept or unavailable/reject.

In an example, AP2 may transmit the response frame 1202 using the TX power that AP1 may have specified/indicated for AP2 in the invite frame 1201. In an example, AP2 may transmit the response frame 1202 with a self-selected TX power. In any case, AP2 may remember the TX power used for the response frame as a power reference for the later power adjustment request it may receive from AP1. In an example, AP2 may (e.g., directly) signal/indicate (e.g., in the response frame 1202) the TX power used for transmitting the response frame 1202.

In an example, AP2 may carry/indicate (e.g., in the response frame 1202) an identifier of STA2, a non-AP STA that AP2 may have queued DL traffic for. In an example, AP2 may indicate (e.g., in the response frame 1202) the priority of its queue traffic to STA2.

In an example, non-AP STAs associated with AP2 may monitor and decode the response frame 1202 to determine that the response frame 1202 may be a Co-SR response frame, and the specified/indicated non-AP STA(s) may follow one or more procedures to prepare for the later Co-SR data transmission.

In an example, STA1 may conduct power measurements on AP2 through the response frame 1202 to obtain any of the RSSI, pathloss, and CQI information of AP2. If AP2 indicates the TX power of the response frame 1202, this may be used to obtain the pathloss from AP2 to STA1.

In an example, STA2, if identified, may conduct power measurements on AP2 through the response frame 1202 to obtain any of the RSSI, pathloss and CQI information of AP2. If AP2 indicates the TX power of the response frame 1202, this may be used to obtain the pathloss from AP2 to STA2.

In an example, the response frame 1202 may comprise any of a TB PPDU and an action frame defined for Co-SR response.

A first ICF frame 1203 may be sent by AP1.

In an example, AP1 may transmit a first ICF frame 1203 to STA1 to confirm STA1's availability to receive the later Co-SR data PPDU.

In an example, the first ICF frame 1203 may comprise a trigger frame, such as any of MU-RTS, BSRP, BSRP-GI3, or a new trigger frame variant, in which AP1 may indicate its TX power e.g., in the common info field.

In an example, AP1 may indicate (e.g., in the first ICF frame 1203) the priority of its queue traffic to STA1.

In an example, STA1 may conduct power measurements on AP1 through the first ICF 1203 to obtain any of RSSI, pathloss, and CQI information of AP1 or to combine with the measurements done through the invite frame 1201 to further improve the measurements. The indicated TX power may be used to obtain the pathloss from AP1 to STA1.

In an example, STA2, if identified in the response frame 1202 and available for receiving the later Co-SR data PPDU from AP2, may conduct power measurements on AP1 through the first ICF 1203 to obtain any of RSSI, pathloss, and CQI information of AP1.

A first initial control response (ICR) frame 1204 may be sent by STA1.

In an example, STA1 may transmit the first ICR frame 1204 to AP1 to confirm its availability or indicate its unavailability to receive the later Co-SR data PPDU.

In an example, STA1 may report/indicate (e.g., in the first ICR frame 1204) its power measurements on any of AP2 and AP1, so that AP1 may obtain these measurements.

In an example, STA1 may indicate (e.g., in the first ICR frame 1204) its TX power used for this first ICR frame 1204.

In an example, AP1 may obtain power measurements from STA1 through this first ICR frame 1204 and may use this information to determine the transmission scheme for the Co-SR data PPDU from AP1 to STA1 and the later ACK schemes for the concurrent Co-SR DL PPDUs.

In an example, AP2 may obtain power measurements from STA1 through this first ICR frame 1204 and may use this information to determine the later ACK schemes for the concurrent Co-SR DL PPDUs.

A second ICF frame 1205 may be sent by AP2.

In an example, AP2 may transmit the second ICF frame 1205 to STA2 to confirm STA2's availability to receive the later Co-SR data PPDU.

In an example, the second ICF frame 1205 may comprise a trigger frame, such as any of a MU-RTS, BSRP, BSRP-GI3, or a new trigger frame variant, in which AP2 may indicate its TX power in e.g., the common info field.

In an example, AP2 may indicate (e.g., in the second ICF frame 1205) the priority of its queue traffic to STA2.

In an example, STA2 may conduct power measurements on AP2 through the second ICF frame 1205 to obtain any of RSSI, pathloss, and CQI information of AP2 or to combine with the measurements done through the response frame 1202 to further improve the measurements. The indicated TX power may be used to obtain the pathloss from AP2 to STA2.

In an example, STA1, if identified in the invite frame 1201 or the first ICF 1203 from AP1 and responding with being available for receiving the later Co-SR data PPDU from AP1, may conduct power measurements on AP2 through the second ICF 1205 to obtain any of RSSI, pathloss, and CQI information of AP2. STA1 may keep the power measurement for later use such as another Co-SR TXOP shared between AP1 and AP2.

A second ICR frame 1206 may be sent by STA2.

In an example, STA2 may transmit the second ICR frame 1206 to AP2 to confirm its availability or indicate its unavailability to receive the later Co-SR data PPDU.

In an example, STA2 may report/indicate (e.g., in the second ICR frame 1206) its power measurements on any of AP1 and AP2, so that AP2 may obtain these measurements.

In an example, STA2 may indicate (e.g., in the second ICR frame 1206) its TX power used for this ICR.

In an example, AP1 may obtain power measurements from STA2 through the second ICR frame 1206 and may use this information to determine the later ACK schemes for the concurrent Co-SR DL PPDUs.

In an example, AP2 may obtain power measurements from STA2 through the second ICR frame 1206 and may use this information to determine the transmission scheme for the Co-SR data PPDU from AP2 to STA2 and the later ACK schemes for the concurrent Co-SR DL PPDUs.

The Co-SR sync/trigger frame 1208 may be sent by AP1.

In an example, AP1 may indicate (e.g., in the Co-SR sync/trigger frame 1208) its own TX power for the subsequent Co-SR DL data PPDU and other determined transmission scheme parameters with STA1 (such as any of MCS, number of spatial streams, coding type, RU allocation, and punctured channels), based on STA1's reported power measurements on AP1 obtained from STA1's first ICR 1204 and/or its link adaptation history data on STA1.

In an example, AP1 may specify/indicate (e.g., in the Co-SR sync/trigger frame 1208) an absolute TX power to be used by AP2 in its subsequent Co-SR DL data PPDU if the pathloss from AP2 to STA1 is known and the tolerable interference level at STA1 can be determined. AP1 may specify/indicate (e.g., in the Co-SR sync/trigger frame 1208) a delta power or power ratio relative to AP2's TX power used for any of AP2's Co-SR response 1202 and the second ICF frame 1205 if STA1 can (e.g., only) obtain an interference power level from AP2 through the power measurements on those frames.

In an example, AP1 may indicate (e.g., in the Co-SR sync/trigger frame 1208) any of (i) the ACK scheme to be used by STA1 when it may be sending ACK regarding the subsequent Co-SR DL data PPDU from AP1 to STA1, and (ii) the ACK scheme to be used by STA2 for STA2′ ACK regarding the subsequence Co-SR DL data PPDU from AP2 to STA2. The determination of the ACK scheme, time/frequency resource to be used, and ACK TX power may depend on AP1's power measurements of STA1 and STA2 through their respective ICR frames.

In an example, AP2 may determine its transmission scheme in its subsequent Co-SR DL data PPDU to STA2 based on the TX power set/indicated by AP1 and the power measurement information it may have on the AP2 to STA2 path. AP2 may, for example, determine how STA2 may send back ACK based on the power measurement information it may have on the STA2 to AP2 path and the STA1 to AP2 path.

The concurrent Co-SR DL data PPDUs 1208 1209 may be sent by AP1 and AP2.

In an example, AP1 may use the same TX power as what it may have used for the invite frame 1201 and/or the first ICF frame 1203. In an example, AP1 may use the TX power indicated in the Co-SR Sync/Trigger frame 1207 (e.g., if different).

In an example, AP2 may adjust its TX power based on what AP1 may have specified/indicated in the Co-SR Sync/Trigger frame 1207. If a delta power or a power ratio indicated, AP2 may use its TX power for the response frame 1202 and/or the second ICF frame 1205 as a reference to make adjustment.

In an example, any of AP1 and AP2 may specify/indicate (e.g., in their respective Co-SR DL data PPDUs 1208 1209) the ACK schemes their respective STAs may use in the following ACK frames.

The ACK frames 1210 1211 may be sent by STA1 and STA2.

In an example, STA1 and STA2 may use the same TX power they may have used on their respective ICR frames 1204 1206 on the ACK frames e.g., unless otherwise specified/indicated by their respective APs.

In embodiments described herein, any feature/characteristic/variant related to the examples described in relation to any of FIGS. 6, 7 and 8 may be combined with any feature/characteristic/variant related to the examples described in relation to any of FIGS. 10 and 11 and/or with any feature/characteristic/variant related to the examples described in relation to FIG. 12. The examples described in relation to any of FIGS. 6, 7 and 8 describe transmissions occurring at a larger time scale (e.g., compared to the examples described in relation to any of FIGS. 10 and 11), such as e.g., one or more times in a beacon interval. The examples described in relation to any of FIGS. 10 and 11 describe transmissions occurring at a smaller time scale such as e.g., once over a plurality of TXOPs. The examples described in relation to FIG. 12 describe transmissions occurring at a (e.g., even) smaller time scale (e.g., compared to the examples described in relation to any of FIGS. 10 and 11) such as e.g., occurring within a TXOP. Transmissions occurring at different time scales may be used separately or combined such as to any of update, perform and complete power measurements and reporting.

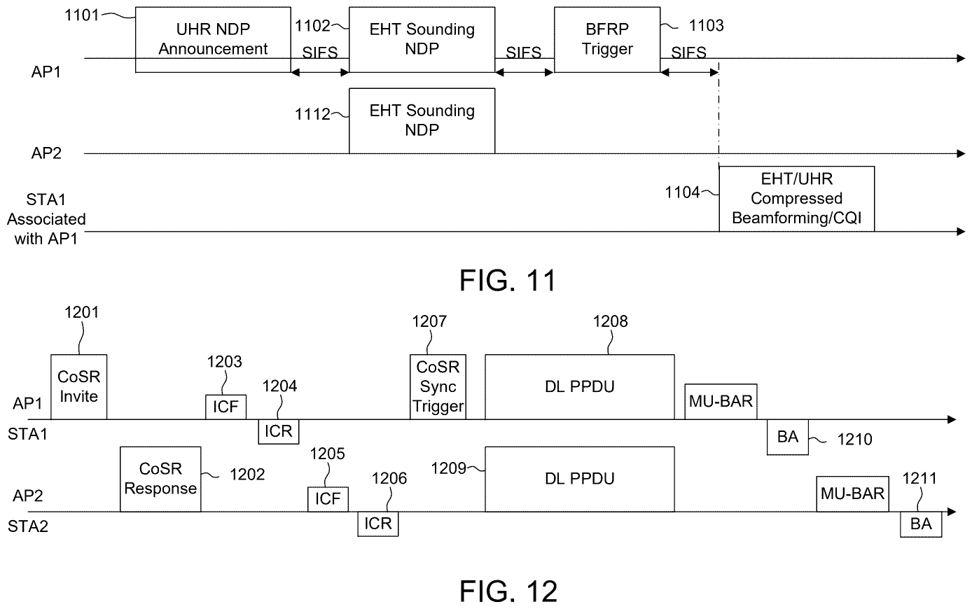

FIG. 13 is a diagram illustrating an example method 1300 for power measurement and report for coordinated spatial reuse transmissions, implemented in a first AP. The first AP may include circuitry including a transmitter, a receiver, a processor, and memory. The circuitry may be configured to carry out the method 1300. As shown at 1310, the method 1300 may include receiving from a first station (STA) associated with the first AP, a first transmission that may include power measurement information and an AP identifier, the AP identifier identifying a second AP. In various embodiments, the power measurement information may be associated with a second transmission received from the second AP and measured at the first STA. In various embodiments, the first STA may not be associated with the second AP. As shown at 1320, the method 1300 may include determining, based on the power measurement information, a power value to be used by the second AP for transmitting a third transmission. As shown at 1330, the method 1300 may include transmitting, to the second AP, a fourth transmission that may include the power value.

In various embodiments, the second transmission may indicate an explicit transmit power level used by the second AP on the second transmission.

In various embodiments, the power measurement information may indicate a path loss between the second AP and the first STA.

In various embodiments, the power measurement information may indicate a received signal strength.

In various embodiments, the method 1300 may further include determining a path loss between the second AP and the first STA based on a difference between the indicated received signal strength and a default transmit power level used by the second AP on the second transmission.

In various embodiments, the method 1300 may further include receiving from the second AP, (e.g., before transmitting the fourth transmission) information indicating the default transmit power level used by the second AP on the second transmission.

In various embodiments, the power value may comprise an absolute transmit power limit to not be exceeded during the third transmission.

In various embodiments, the power value may comprise a power adjustment value to be used with a reference transmit power level during the third transmission.

In various embodiments, the first transmission may include time information (e.g., any of timestamp, measurement token) associated with the power measurement information.

In various embodiments, the fourth transmission may include the time information associated with the power value.

In various embodiments, the method 1300 may further include transmitting to the first STA, a fifth transmission that may share a same set of resources as the second AP may have used for the third transmission.

In various embodiments, the same set of resources may comprise a same set of time resources, a same set of frequency resources, and a same set of spatial stream resources.

In various embodiments, transmitting the fifth transmission may comprise transmitting the fifth transmission based on coordinated spatial reuse with the second AP.

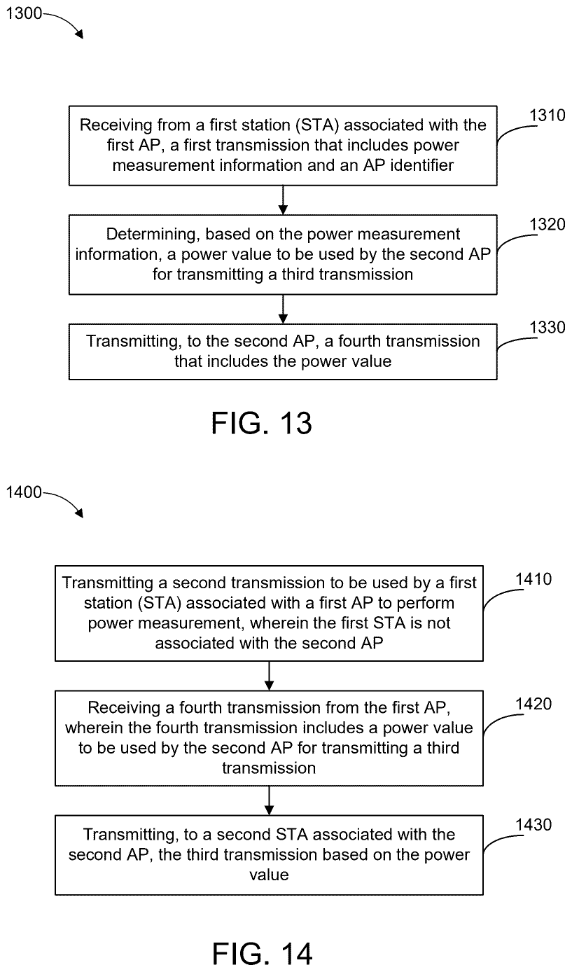

FIG. 14 is a diagram illustrating an example method 1400 for power measurement and report for coordinated spatial reuse transmissions, implemented in a second AP. The second AP may include circuitry including a transmitter, a receiver, a processor, and memory. The circuitry may be configured to carry out the method 1400. As shown at 1410, the method 1400 may include transmitting a second transmission to be used by a first station (STA) associated with a first AP to perform power measurement, the first STA not being associated with the second AP. In various embodiments, the second transmission may include an AP identifier, the AP identifier identifying the second AP. As shown at 1420, the method 1400 may include receiving a fourth transmission from the first AP. In various embodiments, the fourth transmission may include a power value to be used by the second AP for transmitting a third transmission. As shown at 1430, the method 1400 may include transmitting to a second STA associated with the second AP, the third transmission based on the power value. In various embodiments, the third transmission may share a same set of resources as the first AP may have used for a fifth transmission.

In various embodiments, the same set of resources may comprise a same set of time resources, a same set of frequency resources, and a same set of spatial stream resources.

In various embodiments, transmitting the third transmission may comprise transmitting the third transmission based on coordinated spatial reuse with the first AP.

In various embodiments, the second transmission may indicate an explicit transmit power level used by the second AP on the second transmission.

In various embodiments, the method 1400 may further include transmitting to the first AP, information indicating a default transmit power level used by the second AP on the second transmission.

In various embodiments, the power value may comprise an absolute transmit power limit to not be exceeded during the third transmission.

In various embodiments, transmitting the third transmission based on the power value may comprise transmitting the third transmission at a power level lower than or equal to the absolute transmit power limit.

In various embodiments, the power value may comprise a power adjustment value to be used with a reference transmit power level during the third transmission.

In various embodiments, transmitting the third transmission based on the power value may comprise transmitting the third transmission at an adjusted power level. In various embodiments, the adjusted power level may be adjusted based on the power adjustment value relative to the reference transmit power level.

In various embodiments, the reference transmit power level may be equal to the default transmit power level.

In various embodiments, the reference transmit power level may correspond to (e.g., be equal to) a transmit power level used to transmit the second transmission.

In various embodiments, the fourth transmission may include time information associated with the power value.

In various embodiments, the time information may indicate a time at which the second transmission may have been transmitted.

In various embodiments, the time information may indicate a time at which the one or more transmissions may have been transmitted at the reference power level.

Any feature/characteristic/variant described in relation to the first method 1300 implemented in the first AP and illustrated at FIG. 13 may also be applicable to the second method 1400 implemented in the second AP and illustrated at FIG. 14, and vice versa.

In various embodiments, the second transmission may comprise any of a beacon frame and a measurement pilot frame.

In various embodiments, the first transmission may comprise a beacon report action frame.

In various embodiments, the second transmission may comprise a sounding null data packet.

In various embodiments, the first transmission may comprise any of a compressed beamforming and CQI action frame.

In various embodiments, the second transmission may comprise any of a TXOP sharing response frame, a TXOP sharing invite frame, and an initial control frame.

In various embodiments, the first transmission may comprise an initial control response frame.

In various embodiments, the third transmission and the fifth transmission, transmitted respectfully by the second AP and the first AP may comprise a Co-SR data transmission, such as e.g., PPDU transmission.

In various embodiments, the fourth transmission may comprise any MAP information exchange transmission that may be transmitted by an AP of an MAPC agreement to another AP of the MAPC agreement.

Embodiments are described herein with a beacon frame, a measurement pilot frame, a sounding null data packet, a TXOP sharing response frame, a TXOP sharing invite frame, and an initial control frame as examples of second transmissions to enable power measurements. Embodiments described herein are not limited to a beacon frame, a measurement pilot frame, a sounding null data packet, a TXOP sharing response frame, a TXOP sharing invite frame, and an initial control frame. Any transmission that may be transmitted by the second AP and that may be used by a first STA not associated with the second AP to perform power measurements may be applicable to embodiments described herein.

Embodiments are described herein with a beacon report action frame, a compressed beamforming/CQI action frame, and an initial control response frame as examples of first transmissions to report power measurements. Embodiments described herein are not limited to a beacon report action frame, a compressed beamforming/CQI action frame, and an initial control response frame. Any transmission that may be transmitted by the first STA associated with a first AP to report power measurements to the first AP may be applicable to embodiments described herein.

Embodiments are described herein with PPDU transmissions as examples of third and fifth transmissions to perform Co-SR. Embodiments described herein are not limited PPDU transmissions. Any transmission that may be concurrently transmitted by the first AP and the second AP may be applicable to embodiments described herein.

Embodiments are described herein with an MAP information exchange transmission as an example of fourth transmissions from the first AP to the second AP to send power information. Embodiments described herein are not limited to MAP information exchange transmissions. Any transmission that may be transmitted between two APs to exchange power information may be applicable to embodiments described herein.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and memory, the circuitry being operable (e.g., configured) to process the disclosed method, with a computer program product comprising program code instructions and with a non-transitory computer-readable storage medium storing program instructions. Besides, any characteristic, variant or embodiment described for an AP is compatible with a non-AP STA.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

The content of each of the following references is incorporated by reference herein in its entirety:
IEEE Std 802.11™-2020: Part 11: Wireless LAN Medium Access Control (MAC) and Physical Layer (PHY) Specifications, December 2020;
Draft Standard for Information technology—Telecommunications and information exchange between systems Local and metropolitan area networks-Specific requirements; Part 11: Wireless LAN Medium Access Control (MAC) and Physical Layer (PHY) Specifications; Amendment 1: Enhancements for High Efficiency WLAN, IEEE P802.11ax/D8.0 (October 2020);
Draft IEEE Standard for Information technology—Telecommunications and information exchange between systems Local and metropolitan area networks-Specific requirements, “Part 11: Wireless LAN Medium Access Control (MAC) and Physical Layer (PHY) Specifications”, IEEE P802.11-REVme™/D7.0, August 2024;
Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 2: Enhancements for extremely high throughput (EHT),” IEEE P802.11be™/D7.0 (August 2024);
YU, “Specification Framework for TGbn,” IEEE 802.11-24/0209r12, March 2025;
Draft Standard for Information technology—Telecommunications and information exchange between systems Local and metropolitan area networks-Specific requirements; “Part 11: Wireless LAN Medium Access Control (MAC) and Physical Layer (PHY) Specifications; Amendment 6: Enhancements for ultra-high reliability (UHR)”, IEEE P802.11bn™/D0.2, March 2025.

What is claimed is:

1. A first access point (AP) comprising circuitry, including a transmitter, a receiver, a processor, and memory, configured to:
receive from a first station (STA) associated with the first AP, a first transmission that includes power measurement information and an AP identifier, wherein the AP identifier identifies a second AP, wherein the power measurement information is associated with a second transmission received from the second AP and measured at the first STA, and wherein the first STA is not associated with the second AP;
determine, based on the power measurement information, a power value to be used by the second AP for transmitting a third transmission; and
transmit, to the second AP, a fourth transmission that includes the power value.

2. The first AP of claim 1, wherein the second transmission indicates an explicit transmit power level used by the second AP on the second transmission.

3. The first AP of claim 1, wherein the power measurement information indicates a path loss between the second AP and the first STA.

4. The first AP of claim 1, wherein the power measurement information indicates a received signal strength.

5. The first AP of claim 4, configured to determine a path loss between the second AP and the first STA based on a difference between the indicated received signal strength and a default transmit power level used by the second AP on the second transmission.

6. The first AP of claim 5, configured to receive from the second AP, information indicating the default transmit power level used by the second AP on the second transmission.

7. The first AP of claim 1, wherein the power value comprises an absolute transmit power limit to not be exceeded during the third transmission.

8. The first AP of claim 1, wherein the power value comprises a power adjustment value to be used with a reference transmit power level during the third transmission.

9. The first AP of claim 1, wherein the first transmission includes time information associated with the power measurement information.

10. The first AP of claim 9, wherein the fourth transmission includes the time information associated with the power value.

11. The first AP of claim 1, configured to transmit, to the first STA, a fifth transmission that shares a same set of resources as the second AP used for the third transmission.

12. The first AP of claim 11, where the same set of resources comprises a same set of time, frequency, and spatial stream resources.

13. The first AP of claim 11, wherein being configured to transmit the fifth transmission comprises being configured to transmit the fifth transmission based on coordinated spatial reuse with the second AP.

14. A method implemented in a first access point (AP), the method comprising:
receiving from a first station (STA) associated with the first AP, a first transmission that includes power measurement information and an AP identifier, wherein the AP identifier identifies a second AP, wherein the power measurement information is associated with a second transmission received from the second AP and measured at the first STA, and wherein the first STA is not associated with the second AP;
determining, based on the power measurement information, a power value to be used by the second AP for transmitting a third transmission; and
transmitting, to the second AP, a fourth transmission that includes the power value.

15. A second access point (AP) comprising circuitry, including a transmitter, a receiver, a processor, and memory, configured to:
transmit a second transmission to be used by a first station (STA) associated with a first AP to perform power measurement, wherein the first STA is not associated with the second AP, wherein the second transmission includes an AP identifier, and wherein the AP identifier identifies the second AP;
receive a fourth transmission from the first AP, wherein the fourth transmission includes a power value to be used by the second AP for transmitting a third transmission; and
transmit, to a second STA associated with the second AP, the third transmission based on the power value, wherein the third transmission shares a same set of resources as the first AP used for a fifth transmission.

16. The second AP of claim 15, where the same set of resources comprises a same set of time, frequency, and spatial stream resources.

17. The second AP of claim 15, wherein being configured to transmit the third transmission comprises being configured to transmit the third transmission based on coordinated spatial reuse with the first AP.

18. The second AP of claim 15, wherein the second transmission indicates an explicit transmit power level used by the second AP on the second transmission.

19. The second AP of claim 15, configured to transmit to the first AP, information indicating a default transmit power level used by the second AP on the second transmission.

20. The second AP of claim 15, wherein the power value comprises an absolute transmit power limit to not be exceeded during the third transmission.

21-33. (canceled)
